(19) United States
(12) Patent Application Publication
(10) Pub. No.: US 2024/0242611 A1
(43) Pub. Date: Jul. 18, 2024

(54) School Bus Remote Sign Safety Systems and Methods

(71) Applicant: Solar Advanced Warning Systems Inc., Dallas, TX (US)

(72) Inventors: Shane David Howell, Dallas, TX (US); Michael Stuard Merrell, Royse City, TX (US)

(21) Appl. No.: 18/414,279

(22) Filed: Jan. 16, 2024

Related U.S. Application Data
(60) Provisional application No. 63/439,565, filed on Jan. 17, 2023.

(51) Int. Cl. G08G 1/16; G08G 1/09; H04W 4/44

(52) U.S. Cl. CPC G08G 1/162; G08G 1/09; G08G 1/166; H04W 4/44

(57) ABSTRACT

In one instance, a school bus remote sign safety system for alerting drivers on a road to the presence of a stopped or stopping school bus is disclosed. The school bus remote sign safety system has an activation switch located on a school bus, a transmitter located on the school bus capable of transmitting a signal, at least one warning sign positioned alongside a roadway within a stopped bus warning zone, a receiver located along the roadway within or proximate to the stopped bus warning zone for receiving the signal from the transmitter. Activation of the activation switch causes the transmitter to transmit the signal to the receiver when the signal is received by the receiver and the receiver activates the one or more alert lights on the at least one warning sign. In some instances, the activation switch is connected to or part of a warning light switch. Other safety systems are disclosed.

### RELATED APPLICATION

This application claims the benefit of U.S. Provisional Patent Application 63/439,565 filed on Jan. 17, 2023, entitled “School Bus Remote Sign Safety Systems and Methods,” which is incorporated herein in its entirety by reference for all purposes.

### TECHNICAL FIELD

This application is directed, in general, to school bus safety, and more specifically, to school bus remote sign safety systems and methods.

### BACKGROUND

The safety and protection of children going to and from school is of utmost importance. Progress has been made in protecting children through various safety features such as stop arms on buses and flashing lights on the front and back of buses. While advances have been made, further advancements are desired.

### SUMMARY

According to an illustrative embodiment, a school bus remote sign safety system includes an activation switch located on a school bus; a transmitter located on the school bus capable of transmitting a signal; at least one warning sign positioned alongside a roadway within a stopped bus warning zone, having one or more alert lights; a receiver located along the roadway within or proximate to the stopped bus warning zone for receiving the signal from the transmitter. The receiver is in communication with the at least one warning sign. Activation of the activation switch causes the transmitter to transmit the signal to the receiver. The signal is received by the receiver. The receiver activates the one or more alert lights on the at least one warning sign. The one or more alert lights is visible to a driver traveling along the roadway, so that the driver is alerted to the presence of the school bus when the one or more alert lights is activated.

According to an illustrative embodiment, a school bus remote sign safety system includes a school bus lighting subsystem having one or more bus alert lights and an activation switch that selectively activates the bus alert lights; at least one warning sign positioned alongside a road within a warning distance of a designated bus stop and having at least one sign alert light; a signal transmitter associated with the activation switch of the bus lighting subsystem system. When the bus alert lights are activated, an activation signal is transmitted by the signal transmitter. The at least one warning sign has a receiver for receiving the activation signal. The at least one sign alert light is activated in response to the activation signal.

According to an illustrative embodiment, a school bus remote sign safety system includes an activation switch located on a school bus; a transmitter located on the school bus operable to transmit a wireless signal; a first warning sign positioned alongside a roadway within a stopped bus warning zone, having a first plurality of alert lights that can be selectively activated; a second warning sign positioned alongside a roadway proximate to a stopped bus warning zone, having a second plurality of alert lights that can be selectively activated; a first receiver located along the roadway within or proximate to the stopped bus warning zone for receiving the wireless signal from the transmitter; a second receiver located along the roadway within or proximate to the stopped bus warning zone for receiving the wireless signal from the transmitter.

The first warning sign is on one side of the roadway and the second warning sign is on an opposite side of the roadway from the first warning sign. The first receiver is communicatively coupled to the first warning sign to activate the first plurality of alert lights. The second receiver is communicatively coupled to the second warning sign to activate the second plurality of alert lights. Activation of the activation switch causes the transmitter to transmit the wireless signal to the first receiver and the second receiver. When the wireless signal is received by the first receiver, the first receiver activates the first plurality of alert lights on the first warning sign. When the wireless signal is received by the second receiver, the second receiver activates the second plurality of alert lights on the first warning sign. The transmitter is electrically coupled to the activation switch to be controlled thereby. Other systems and devices are disclosed further below.

### DESCRIPTION OF THE DRAWINGS

Illustrative embodiments of the present invention are described in detail below with reference to the attached drawing figures, which are incorporated by reference herein and wherein:

FIG. 1 is a schematic diagram of an illustrative embodiment of a school bus remote safety system;

FIG. 2 is a schematic diagram of an illustrative embodiment of the school bus remote safety system showing a bus on a hill; and

FIG. 3 is a schematic plan view of an illustrative embodiment of a school bus remote safety system.

### DETAILED DESCRIPTION

In the following detailed description of the preferred embodiments, reference is made to the accompanying drawings that form a part hereof, and in which is shown, by way of illustration, specific embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the claims.

Unless otherwise indicated, as used throughout this document, “or” does not require mutual exclusivity.

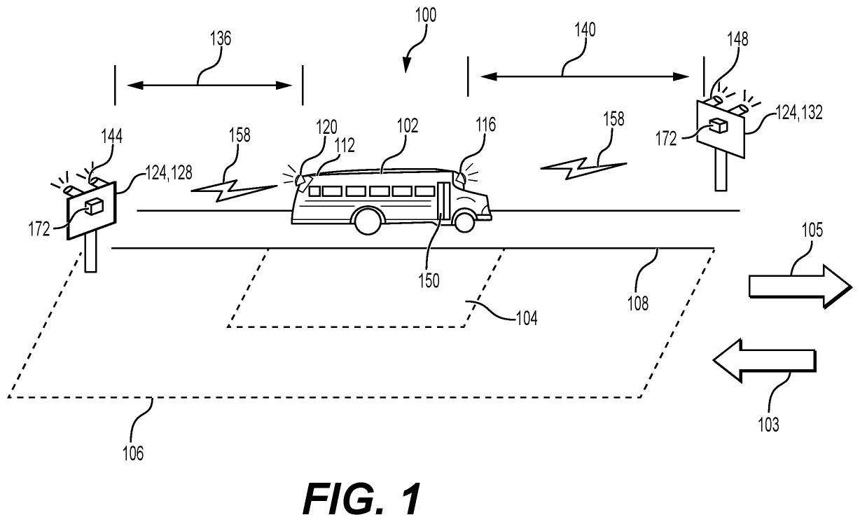

Referring now to the figures and primarily to FIG. 1, an illustrative embodiment of a school bus remote sign safety system 100 is presented. The remote safety sign system 100 includes warning signs 124 located within a stopped bus warning zone 106. In this instance, there is a first warning sign 128 and a second warning sign 132. The use of two warning signs 124 is illustrative. Other embodiments may have only one sign 124 or may have a plurality of warning signs 124. Also located within the stopped bus warning zone 106 is a bus stop 104. The bus stop 104 is a predetermined location alongside or proximate to a road 108, at which a school bus 102 stops to allow passengers to enter or exit the bus 102. The road 108 may be any type of road or roadway used for vehicular travel. The stopped bus warning zone 106 is a zone in which drivers traveling along the road 108 will need to be warned of the presence of a stopped or stopping school bus 102 at or proximate to the bus stop 104. The length of the stopped bus warning zone 106 may vary based on the particular factors of the bus stop 104 such as the nature of the terrain near the bus stop 104, the speed limit along the road 108, the nature of the road 108 (such as number of lanes, directions of travel, etc.). The stopped bus warning zone 106 should be at least large enough that when alert lights 144, 148 on warning signs 128, 132 are activated, the drivers traveling along the road 108 have sufficient time to stop before the drivers reach the bus stop 104.

In the illustrative embodiment of FIG. 1, the first warning sign 128 is located a distance 136 from the bus stop 104, and the second warning sign 132 is located a distance 140 from the bus stop 104, along the length of the road 108. The stopped bus warning zone 106, in this embodiment, is the distance from the first warning sign 128 to the second warning sign 132. In other embodiments, the stopped bus warning zone 106 may vary. For example, in the case of a one-way road, the second warning sign 132 may not be needed because drivers are not traveling along the road 108 toward the school bus 102 in the direction from the second warning sign 132 toward the school bus 102. In this example, the stopped bus warning zone 106 is the distance from the first warning sign 128 to the bus stop 104. In another example, a third warning sign may be desired to provide a larger warning zone for oncoming traffic, for example, a third warning sign may be placed along the road 108 further away from the bus stop 104 than the second warning sign 132 to provide drivers approaching the school bus 102 additional time to stop. In this example, the stopped bus warning zone 106 is the distance between the first warning sign 128 and the third warning sign. In other embodiments, instead of determining the size of the stopped bus warning zone 106 by the placement of the warning signs 124, the size of the stopped bus warning zone 106 is determined by the distance needed to warn drivers on the road 108 as to the presence of the school bus 102 with sufficient time for the drivers to stop their vehicles prior to reaching the bus stop 104.

The school bus 102, in this embodiment, is traveling in a second direction 105 along the road 108. The first warning sign 128 is positioned so that the alert lights 144 and a front side of the first warning sign 128 are directed toward drivers travelling in the same second direction 105 as the school bus and these drivers are alerted to the presence of the school bus when the one or more alert lights 144 of the first warning sign 128 is activated. The second warning sign 132 is positioned so that the alert lights 148 and a front side of the second warning sign 132 are directed toward drivers travelling in a first direction 103 that is opposite from the second direction 105 of travel of the school bus 102 and these drivers are alerted to the presence of the school bus 102 when the one or more alert lights 148 of the second warning sign 132 are activated.

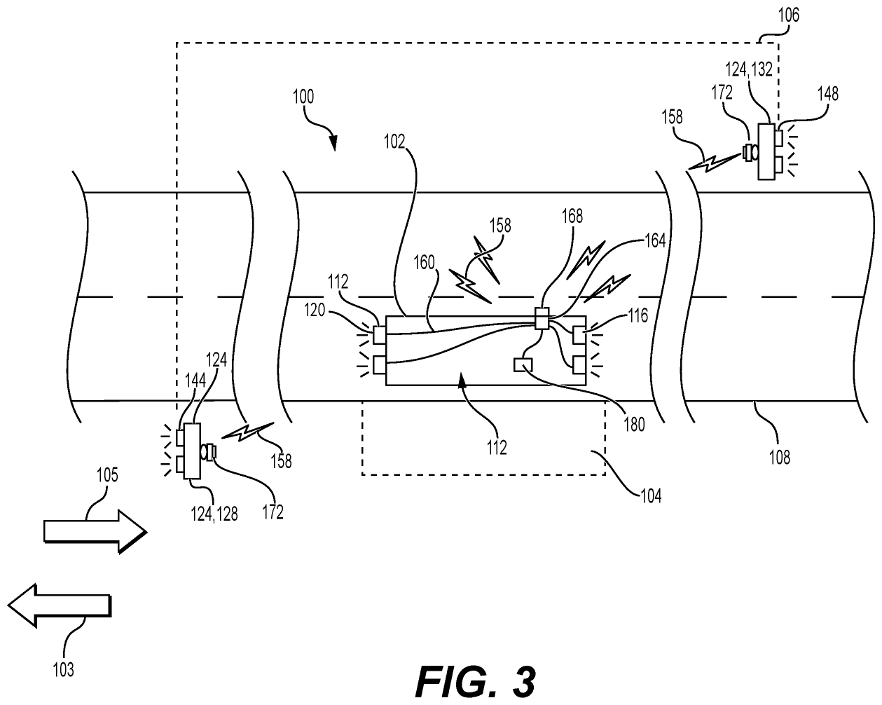

The remote sign safety system 100 of FIG. 1 also includes an activation switch 164 and a transmitter 168 (both are shown in FIG. 3) located on the school bus 102. The remote sign safety system 100 of FIG. 1 also includes receivers 172 located on warning signs 124. When the activation switch 164 is activated, this causes the transmitter 168 to transmit signal 158. Signal 158 is received by the receivers 172. Upon receipt of the signal 158 by the receivers 172, an alert light 144 of the first warning sign 128 and an alert light 148 of the second warning sign 132 are activated. Each warning sign 124, 128, 132 may have a plurality of warning lights 144, 148 which are all activated upon receipt of the signal 158. The warnings may be illuminated with a solid pattern or flashing pattern.

The warning signs 124 and the warning lights 144, 148 are placed so that drivers approaching the school bus 102 along the road 108 will be warned of the presence of a stopped or stopping school bus 102 located within the stopped bus warning zone 106. Since the warning signs 124 are located proximate to the road 108, on coming drivers can see the warning signs 124 and the alert lights 144, 148. As used herein, “proximate to the road” 108 means close enough to the road 108 so that on coming drivers can clearly see the warning signs 124 while driving on the road 108. In some embodiments, the warning signs 124 are located within 15 feet from an edge of the road 108 and in another within 5 feet. Those skilled in the art will appreciate that the distances and dimensions may be varied in different applications.

The distance 136 and the distance 140 should be long enough to provide oncoming drivers with ample warning that the school bus 102 is located within the stopped bus warning zone 106, but at the same time, should not be so long that the receiver 172 is not able to receive the signal 158 transmitted by the transmitter 168. The acceptable maximum distances between the transmitter 168 and a receiver 172 will vary by application and the type of signal used.

The signal 158 can be any signal to communicate between the transmitter 168 and the receiver 172. For example, the signal may be, a radio frequency (RF) signal, a Bluetooth signal, a satellite communication, global positioning system (GPS), radar communication, radio broadcast, cellular communication, Wi-Fi, or another kind of signal transmission. In some embodiments, the maximum distance between the warning signs 124 and the bus stop 104 is 1,000 feet, 1,500 feet, 2640 feet, or 3,000 feet, or any warning distance. A “warning distance” is a distance that provides adequate distance for an approaching car to be warned or alerted and have time to brake to reasonable speed or safe stop. This ensures that the distance between the transmitter 168, which is located on the school bus 102, is within an acceptable distance of the receivers 172, while the school bus 102 is located within the stopped bus warning zone 106, for the receivers 172 to receive the signal 158 from the transmitter 168, i.e., in the illustrative embodiment of FIG. 1, the distance 136 and the distance 140 are each 2,640 feet. The distance in other embodiments may be larger or smaller. In some embodiments, the warning signs 124 are located no farther than 640-650 feet from the bus stop 104. Those skilled in the art will appreciate that other dimension may be used in different situations.

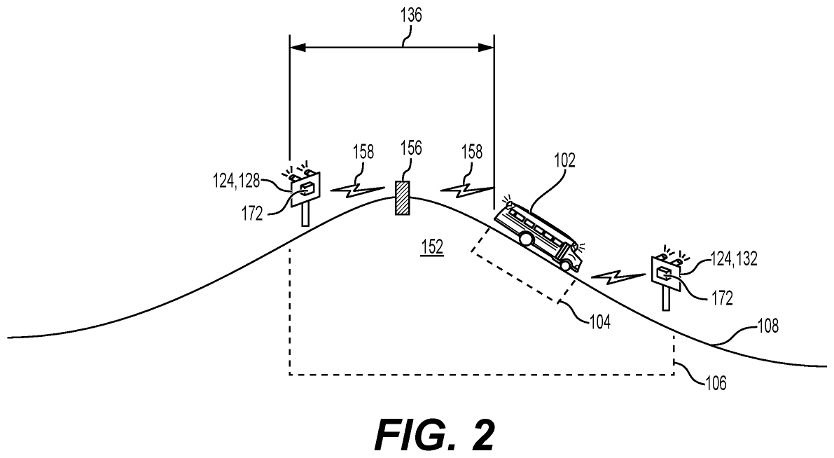

Referring now primarily to FIG. 2, another embodiment of the school bus remote sign safety system 100 is shown. This embodiment of the remote sign safety system 100 is analogous to that of FIG. 1, except that a repeater 156 has been added to the remote sign safety system 100. In certain circumstances it is desirable to increase the distance that signal 158 is able to be reliably transmitted from the transmitter 168 to the receiver 172 or receivers. In such cases, it may not be feasible to reliably transmit the signal 158 to the receiver 172 and at the same time locate the warning signs 124 far enough away from the bus stop 104 to warn oncoming drivers of the presence of a stopped or stopping school bus 102 within the stopped bus warning zone 106 with enough advanced warning to allow drivers to stop before reaching the bus stop 104.

Such an example is presented in FIG. 2. In FIG. 2, a hill 152 is located between the bus stop 104 and the first warning sign 128. The first warning sign 128 cannot be located between the hill 152 and the bus stop 104 because if it was the distance 136 would be too short for oncoming drivers to stop before reaching bus stop 104. However, since the hill 152 is between the bus stop 104 and the first warning sign 128, when the school bus 102 is located at the bus stop 104, the hill 152 may block transmission of the signal 158 from the transmitter 168 because the transmitter 168 is located on the school bus 102. In this case, the repeater 156 has been added to the remote sign safety system 100.

The repeater 156 is located at the top of the hill 152 so that the repeater 156 has communication with both the transmitter 168 and the receiver 172 of the first warning sign 128 when the school bus 102 is at the bus stop 104. In some instances, the transmitter 168 and the receiver 172 are in line of sight of the repeater 156 to improve transmission of the signal 158. Instead of the signal 158 being directly transmitted to the receiver 172 of the first warning sign 128, the signal 158 is first transmitted to the receiver 158 which then retransmits the signal 158 to the first warning sign 128. In this illustrative embodiment, the signal 158 is also directly transmitted to the receiver 172 of the second warning sign 132, as described in relation to the embodiment of FIG. 1.

While the illustrative embodiment of FIG. 2 shows only one repeater 156, other embodiments may include a plurality of repeaters 156 as needed to ensure communication between the transmitter 168 and one or more receivers 172. For example, multiple hills or other obstructions may exist between the transmitter 168 and a receiver 172. In this situation, multiple repeaters 156 can be used to continue the transmission of the signal 158 to the receiver 172. Multiple repeaters 156 may be placed along the road 108 between the transmitter 168 proximate the bus stop 104 and the receiver 172, and the signal 158 can be passed daisy chain style from one repeater 156 to another repeater 156 until the signal 158 reaches the receiver 172. Other embodiments may include multiple repeaters 156 that are each placed and configured within or proximate to the stopped bus warning zone 106 where different repeaters 156 are intended to ensure transmission of the signal 158 to the receivers 172 of different warning signs 124. In other embodiments, multiple repeaters 156 may be used to extend the length of the stopped bus warning zone 106, even without terrain or other obstacles that interfere with transmission of the signal 158. Since repeaters 156 are not components that need to be visible to drivers on the road 108, the repeaters 156 may be placed further from the road 108 than the warning signs 124 or may even be located outside of the stopped bus warning zone 106.

Use of the illustrative embodiment of the school bus remote sign safety system 100 depicted in FIG. 2, which includes the repeater 156, may be particularly useful in rural areas. Rural school buses 102 stop at many bus stops 104 and pick up passengers on county roads or other smaller roads. Such roads often have relatively high-speed limits, e.g., 65 miles per hour or more. In addition, many of these bus stops 104 are treacherous because of hills or blind curves or other dangers.

However, use of the illustrative embodiment of the school bus remote sign safety system 100 depicted in FIG. 2 is not limited to rural areas. For example, the illustrative embodiment of the school bus remote sign safety system 100 depicted in FIG. 2 may be used in any situation in which transmission of the signal 158 is blocked or reduced by any obstacle or obstruction. For example, urban areas may contain other blocking features such as large buildings in addition to hills, other terrain features, blind curves that reduce or block transmission the signal 158.

Referring now primarily to FIG. 3, additional details of the illustrative embodiments of the school bus remote sign safety systems 100 of FIGS. 1 and 2 are shown. The school bus 102 is shown stopped at the bus stop 104, which is a designated pick-up/drop-off area located proximate to the road 108. The school bus 102 has a school bus lighting subsystem 112 that includes front mounted lights 116 and rear mounted lights 120 to alert approaching cars that children or other passengers may be exiting the bus 102. The school bus lighting subsystem 112 is shown with lights 116 and 120 electrically coupled by wires 160 to an activation switch 164. The school bus lighting subsystem 112 is activated by the switch 164 located on the school bus 102. When a school bus driver wishes to warn oncoming drivers that the school bus 102 is stopped, stopping, or loading or unloading passengers the school bus driver activates the school bus lighting subsystem 112 using the switch 164. This turns on front mounted lights 116 and rear mounted lights 120 so that drivers that can see the school bus 102 are visibly notified about the presence of the school bus 102.

The remote sign safety system 100 is, in this illustrative embodiment, is also activated by the activation switch 164. When the activation switch 164 is activated, this in turn activates the transmitter 168. Upon activation, the transmitter 168 sends out signal 158, which is in turn received by the receivers 172. Upon receipt of the signal 158 by the receivers 172, the alert lights 144, 148 are activated, or turned on. By using this configuration, the school bus driver only has to activate one switch, i.e., the switch 164, to activate both the school bus lighting subsystem 112 and the remote sign safety system 100. Once the signal 158 is received by the receiver 172 of the warning sign 124, the lights 144, 148 are triggered and stay on for a certain time period. The duration that the lights 144, 148 will remain on will be for as long as the signal 158 continues to be received by the receiver 172. In other embodiments, the lights 144, 148 may remain on for a predetermined amount of time beginning at the time the signal 158 is received. In some examples, the predetermined amount of time may be 30 seconds, 3 minutes, 5 minutes, or a sufficient time for the bus to unload or load passengers and to get back up to speed.

In other embodiments, other configurations of the switch 164 may be used to activate the transmitter 168. For example, the activation switch 164 may not be wired into the school bus lighting subsystem 112, which may be activated using a different switch. In this manner, the school bus driver can selectively activate the school bus lighting subsystem 112 and the remote sign safety system 100. In other embodiments, the switch 164 of the remote sign safety system 100 may be activated in other manners. For example, the switch 164 may be connected to a door opening mechanism of the school bus 102, so that when a door 150 of the school bus is opened, the switch 164 is activated and the signal 158 is being transmitted. In this manner, each time the school bus driver stops to let passengers load or unload from the school bus 102, the remote sign safety system 100 is active anytime the school bus door 150 is open. In other embodiments, the switch 164 may be tied into a braking system or a brake lighting system of the school bus 102. In this embodiment, the switch 164 is activated anytime the school bus driver applies brakes to slow the school bus 102 or the brake lighting system of the school bus 102 is active. Therefore, in this embodiment, the remote sign safety system 100 would be activated and oncoming drivers would be alerted to the presence of the school bus 102 within the stopped bus warning zone 106 any time the school bus driver applies the school bus brakes and the transmitter 168 is within transmission distance of any receiver 172.

In another illustrative embodiment, the remote sign safety system 100 may not include a switch 164 as such and, instead, the transmitter 168 may be wired to transmit the signal 158 any time the school bus 102 is turned on. By using this configuration, the need to activate any switch is eliminated. The warning signs 124 will each be activated once the school bus 102 comes within transmission range so that signal 158, which is being continuously broadcast by the transmitter 168, reaches the receiver 172.

In another embodiment, activation of the remote sign safety system 100 may be accomplished using GPS information of a GPS receiver 180 located on the school bus 102. In this embodiment, the GPS receiver 180 may be programmed to automatically activate the switch 164 any time the school bus is in or near to a stopped bus warning zone 106. The GPS coordinates of the stopped bus warning zone 106 or the bus stop 104 may be preprogramed into the GPS receiver, and the GPS receiver 180 may activate the switch 164 anytime the GPS receiver 180 detects that the school bus 102 is located within a certain distance of such coordinates.

In other embodiments, the communication pathway of the signal 158 may vary as compared to that described in relation to the illustrative embodiments of FIGS. 1-3. For example, the receivers 172 may be configured to not only receive the signal 158 and to activate the alert lights 144, 148, but may also be configured to resend the signal 158, in the same manner that the repeater 156 would resend the signal 158. In this manner, the signal 158 may be received by the receiver 172 of the first warning sign 128 and then rebroadcast the signal 158 to the receiver 172 of the second warning sign 132, as opposed to the signal 158 being received by the receiver 172 of the second warning sign 132 directly.

In other embodiments, the first warning sign 128 and the second warning sign 132 or an additional warning sign 124 (and receivers 172 and repeaters 156) may be placed on different roads. For example, in the case of a bus stop 104 located on the road 108 and near to a second road that intersects the road 108, it may be desirable to warn both drivers on the road 108 and the drivers on the intersecting second road that a school bus is present in the stopped bus warning zone 106 of the road 108. In this embodiment, a first warning sign 128 and a second warning sign 132 may be placed proximate to the road 108 to warn drivers traveling on the road 108 about the school bus, as described above. In addition, an additional warning sign 124 (and receivers 172 and repeaters 156 as needed) may be placed proximate to the intersecting second road to warn drivers traveling along the intersecting second road as to the presence of the school bus 102 on the road 108.

In other embodiments, the location of the receiver 172 may vary as compared to as described in relation to the illustrative embodiments of FIGS. 1-3. In the embodiments of FIG. 1-3, the receivers 172 are shown as being part of or attached to the warning signs 124. In alternative embodiments, the receivers 172 may be separate components of the remote sign safety system 100 that are not attached to the warning signs 124. For example, a receiver 172 may be located within a stopped bus warning zone 106 and not attached to a warning sign 124. The receiver 172 may be located proximate to the road 108. The receiver 172 may be electrically connected to or in communication with the alert lights 144, 148 so that the receiver can activate the alert lights 144, 148 upon receipt of the signal 158. In this manner, the receiver 172 can be placed in a location that is more likely to receive the signal 158 and the warning signs 124 can be placed in a location that is more likely to provide adequate notice to drivers on the road 108 of the presence of a school bus 102 within the stopped bus warning zone 106. In other embodiments, the receiver 172 may be mounted so that it is elevated, relative to a height of the warning signs 124, to improve the transmission of the signal 158 to the receiver 172. Since receivers 172 are not components that need to be visible to drivers on the road 108, the receivers 172 may be placed further from the road 108 than the warning signs 124 or may even be located outside of the stopped bus warning zone 106.

In still another embodiment, the activation switch may be activated by a set schedule. The activation switch activates based on a pre-programmed schedule of bus stop times with a margin of error.

Communicatively coupled means coupled by wire or wireless signal to allow a signal to activate or communicate with some aspect of the system.

A number of examples have been presented. Additional examples follow:

Example 1. A school bus remote sign safety system comprising:
a school bus lighting subsystem comprising bus alert lights and an activation switch that selectively activates the bus alert lights;
at least one warning sign positioned on a road within warning distance of a designated bus-stop zone and comprising at least one sign alert light;
a signal transmitter associated with the activation switch of the bus lighting subsystem system, whereby when the bus alert lights are activated, an activation signal is sent; and
wherein the at least one warning sign has a receiver for receiving the activation signal and whereby the at least one sign alert light is activated in response to the activation signal.

Example 2. The school bus remote sign safety system of Example 1 further comprising a signal repeater that receives the activation signal and resends the activation signal to allow greater distances or to accommodate terrain.

Although the present invention and its advantages have been disclosed in the context of certain illustrative, non-limiting embodiments, it should be understood that various changes, substitutions, permutations, and alterations can be made without departing from the scope of the invention as defined by the claims. It will be appreciated that any feature that is described in a connection to any one embodiment may also be applicable to any other embodiment.

What is claimed:

1. A school bus remote sign safety system comprising:
an activation switch located on a school bus;
a transmitter located on the school bus communicatively coupled to the activation switch and capable of transmitting a signal;
at least one warning sign positioned alongside a roadway within a stopped bus warning zone, wherein the at least one warning sign has one or more alert lights;
a receiver located along the roadway within or proximate to the stopped bus warning zone for receiving the signal from the transmitter, the receiver being in communication with the at least one warning sign;
wherein, activation of the activation switch causes the transmitter to transmit the signal to the receiver;
wherein, when the signal is received by the receiver, the receiver activates the one or more alert lights on the at least one warning sign;
wherein, the one or more alert lights is visible to a driver traveling along the roadway, so that the driver is alerted to the presence of the school bus when the one or more alert lights is activated.

2. The school bus remote sign safety system of claim 1, wherein the stopped bus warning zone is a zone along the roadway with a length of 2,640 feet or less from either side of a designated bus stop.

3. The school bus remote safety sign system of claim 1,
wherein, the at least one warning sign comprises a first warning sign and a second warning sign;
wherein, the first warning sign is located alongside the roadway and positioned so that drivers approaching the school bus from an opposite direction of travel of the school bus are alerted to the presence of the school bus when the one or more alert lights of the first warning sign is activated; and
wherein, the second warning sign is located alongside the roadway and positioned so that drivers approaching the school bus from the same direction of travel of the school bus are alerted to the presence of the school bus when the one or more alert lights on the second warning sign is activated.

4. The school bus remote safety sign system of claim 1, further comprising a signal repeater located alongside the roadway that receives the signal from the transmitter and resends the signal to the receiver.

5. The school bus remote safety sign system of claim 4, wherein the signal repeater is used to transmit the signal from the transmitter to the receiver when communication between the transmitter and the receiver is otherwise blocked or reduced by terrain or other obstacles between the transmitter and the receiver.

6. The school bus remote safety sign system of claim 1,
wherein, the activation switch is connected to or part of a warning light switch used to activate warning devices located on the school bus to notify drivers along the roadway that the school bus is stopping or is stopped; and
wherein, activation of the warning light switch results in activation of the activation switch to cause the transmitter to send the signal.

7. The school bus remote safety sign system of claim 1,
wherein, the activation switch is connected to or part of a brake light system used to activate brake lights located on the school bus to notify drivers along the roadway that the school bus is stopping or is stopped; and
wherein, activation of the brake light system results in activation of the activation switch to cause the transmitter to send the signal.

8. The school bus remote safety sign system of claim 1, wherein the activation switch is activated by an electrical system on the school bus being activated.

9. The bus safety alert system of claim 1, wherein the activation switch is activated any time the school bus is running.

10. The school bus remote safety sign system of claim 1,
wherein the stopped bus warning zone is a zone along the roadway with a length of 2,640 feet or less from either side of a designated bus stop located alongside the roadway;
wherein, the at least one warning sign comprises a first warning sign and a second warning sign;
the first warning sign is located alongside the roadway and positioned so that drivers approaching the school bus from an opposite direction of travel of the school bus are alerted to the presence of the school bus when the one or more alert lights of the first warning sign is activated;
the second warning sign is located alongside the roadway and positioned so that drivers approaching the school bus from the same direction of travel of the school bus are alerted to the presence of the school bus when the one or more alert lights of the second warning sign is activated;
wherein, the activation switch is connected to or part of a warning light switch used to activate warning devices located on the school bus to notify drivers along the roadway that the school bus is stopping or is stopped; and
wherein, activation of the warning light switch results in activation of the activation switch to cause the transmitter to send the signal.

11. A school bus remote sign safety system comprising:
a school bus lighting subsystem comprising one or more bus alert lights and a bus light activation switch that selectively activates the bus alert lights;
at least one warning sign positioned alongside a road within a warning distance of a designated bus stop and comprising at least one sign alert light;
a signal transmitter associated with the bus light activation switch of the bus lighting subsystem system;
wherein, when the bus alert lights are activated, an activation signal is transmitted by the signal transmitter;
wherein, the at least one warning sign has a receiver for receiving the activation signal; and
wherein, the at least one sign alert light is activated in response to the activation signal.

12. The school bus remote sign safety system of claim 11,
wherein, the at least one warning sign comprises a first warning sign and a second warning sign;
wherein, the first warning sign is located alongside the roadway and positioned so that drivers approaching the school bus from an opposite direction of travel of the school bus are alerted to the presence of the school bus when the one or more alert lights of the first warning sign is activated; and
wherein, the second warning sign is located alongside the roadway and positioned so that drivers approaching the school bus from the same direction of travel of the school bus are alerted to the presence of the school bus when the one or more alert lights of the second warning sign is activated.

13. The school bus remote sign safety system of claim 11, further comprising a signal repeater located alongside the roadway that receives the signal from the transmitter and resends the signal.

14. The school bus remote safety sign system of claim 13, wherein the signal repeater is used to transmit the signal from the transmitter to the receiver when communication between the transmitter and the receiver is otherwise blocked or reduced by terrain or other obstacles between the transmitter and the receiver.

15. The school bus remote safety sign system of claim 13, wherein the warning distance is between 1,000 and 3,000 feet.

16. A bus safety alert system comprising:
an activation switch located on a school bus;
a transmitter located on the school bus operable to transmit a wireless signal, wherein the transmitter is communicatively coupled to the activation switch to be controlled thereby;
a first warning sign positioned alongside a roadway within a stopped bus warning zone, wherein the first warning sign has a first plurality of alert lights that can be selectively activated;
a second warning sign positioned alongside a roadway proximate to a stopped bus warning zone, wherein the second warning sign has a second plurality of alert lights that can be selectively activated;
wherein the first warning sign is on one side of the roadway and the second warning sign is on an opposite side of the roadway from the first warning sign;
a first receiver located along the roadway within or proximate to the stopped bus warning zone for receiving the wireless signal from the transmitter, wherein the first receiver is communicatively coupled to the first warning sign to activate the first plurality of alert lights;
a second receiver located along the roadway within or proximate to the stopped bus warning zone for receiving the wireless signal from the transmitter, wherein the second receiver is communicatively coupled to the second warning sign to activate the second plurality of alert lights;
wherein, activation of the activation switch causes the transmitter to transmit the wireless signal to the first receiver and the second receiver;
wherein, when the wireless signal is received by the first receiver, the first receiver activates the first plurality of alert lights on the first warning sign; and
wherein, when the wireless signal is received by the second receiver, the second receiver activates the second plurality of alert lights on the first warning sign.

17. The bus safety alert system of claim 16, wherein the activation switch is activated any time the school bus is running.

18. The bus safety alert system of claim 16, wherein, the activation switch is connected to or part of a warning light switch used to activate warning devices located on the school bus to notify drivers along the roadway that the school bus is stopping or is stopped.

19. The school bus remote sign safety system of claim 16, further comprising a signal repeater located alongside the roadway that receives the signal from the transmitter and resends the signal.

20. The school bus remote safety sign system of claim 19, wherein the signal repeater is used to transmit the signal from the transmitter to the receiver when communication between the transmitter and the receiver is otherwise blocked or reduced by terrain or other obstacles between the transmitter and the receiver.
